(19) United States
(12) Patent Application Publication
(10) Pub. No.: US 2019/0311277 A1
(43) Pub. Date: Oct. 10, 2019

(54) DYNAMIC CONDITIONING FOR ADVANCED MISAPPROPRIATION PROTECTION

(71) Applicant: BANK OF AMERICA CORPORATION, Charlotte, NC (US)

(72) Inventors: Eren Kursun, New York, NY (US); Hylton van Zyl, Atlantic Highlands, NJ (US)

(21) Appl. No.: 15/947,067

(22) Filed: Apr. 6, 2018

(51) Int. Cl. G06N 5/04; G06N 99/00

(52) U.S. Cl. CPC G06N 5/043; G06N 99/005

(57) ABSTRACT

Embodiments of the invention are directed to systems, methods, and computer program products for dynamic conditioning for advanced misappropriation protection. The system identifies new/emerging misappropriations and profiles them into synthetic data streams via distribution of the misappropriation into a separate channel and allowing processing. Processing the misappropriation allows for analytical data generation and synthetic misappropriation generation. The synthetic stream is injected into a matrix of learning engines for learning of the misappropriation. The learning engines monitor and report each other and are arranged in an architecture form for an implicit internal feedback loop and an explicit external feedback loop.

### BACKGROUND

Artificial Intelligence systems that incorporate a number of intelligent agents participating in tasks are becoming more common. Currently their application areas range from detecting/controlling environmental set up, medical sensors and actuators, and security systems.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Determining the authenticity of users for application can be challenging as users have wide ranges of diversity in resource distribution patterns, health care, data points, interactions, transactions over time, and the like. The system utilizes a dynamic conditioning for advanced misappropriation protection.

Furthermore, Artificial Intelligence systems (AI) that incorporate intelligent agents participating in tasks are becoming more common. Their application areas range from detecting/controlling environmental set up, such as in smart homes/buildings/cities, traffic control/smart vehicles, medical sensors and actuators, misappropriation detection, security systems. The solution/system described here proposes targets situations where the system of intelligent agents need to meet criteria such as accuracy, fairness, compliance to regulations and policies. This system is described through a misappropriation detection use case, however the described techniques, systems and processes apply to other systems and scenarios as mentioned above.

The system provides misappropriation profiling for authenticity identification 800, in accordance with embodiments of the present invention. Misappropriation profiling identifies new/emerging misappropriations that are developed. The misappropriation profiling the new/emerging misappropriations into a separate channel and allows the individual to continue the misappropriation. The system gathers analytical data on the misappropriation and generates a synthetic misappropriation based on the misappropriation and injects the synthetic misappropriation into the authenticity identification streams and the neural network engines for future misappropriation identification.

Embodiments of the invention relate to systems, methods, and computer program products for real-time dynamic conditioning, comprising one or more artificial intelligence (AI) engines within a collection of one or more engines dynamically performing dynamic conditioning, including: self-evaluating an output each of the one or more engines via performing policy checks and assessments on each of the one or more engines own results; evaluating an output from other one or more engines within the collection, wherein evaluating the output from the other one or more engines includes generating synthetic data, performing observations, and/or running compliance checks of the other one or more engines; and dynamically assigning and changing responsibilities of the one or more engines within the population.

In some embodiments, self-evaluating each of the one or more engines further comprises implementing policies on fairness, explainability, and optimization criteria via the self-evaluation and assessment and control of the engine.

In some embodiments, the invention further comprising dynamic optimization and adversarial configuration of real-time streaming data, wherein each of the one or more engines comprise a collection of one or more distributed targeting artificial intelligence engines.

In some embodiments, the invention further comprises fairness and compliance output monitoring comprising generating an implicit internal feedback loop, were each of the one or more engines evaluates each of the one or more engines results overtime and an explicit external feedback loop where the engines are responsible for evaluation and correcting other engine results.

In some embodiments, dynamically assigning and changing the responsibilities of the one or more engines within the population further comprises a point system for assessment of the output and forcing the one or more engines to comply with policies or regulations.

In some embodiments, the invention comprises generating an authenticity identification procedure, wherein the authenticity identification procedure comprise the one or more engines for dynamic optimization and adversarial configuration of real-time streaming data; building a synthetic misappropriation packet for injection, wherein the synthetic misappropriation packet contains a synthetic version of misappropriated resource distribution identified and built using gathered data regarding the misappropriated resource distribution; injecting the synthetic misappropriation packet into a population of the one or more engines associated with the authenticity identification procedures for learning of the emerging misappropriation; and placing responsibility on the learning engines for reporting and evaluation for self-evaluation and correction of results from ingestion of injected synthetic misappropriation packet. In some embodiments, the invention further comprises identifying a resource distribution being initiated as a non-authentic resource distribution based on the one or more authenticity identification procedures, wherein the non-authentic resource distribution is a misappropriated resource distribution; reviewing the misappropriated resource distribution and identify the misappropriated resource distribution as an emerging misappropriation; redirecting the misappropriated resource distribution to an alternative channel and allow for the misappropriated resource distribution to continue; and gathering data regarding communication with an individual of the misappropriated resource distribution.

In some embodiments, evaluating an output from other one or more engines within the collection further comprising a collaborative/distrusted protocol for assessing the overall quality of a solution, such as assessing the reporting and evaluation responsibilities of the learning engines and dynamically optimizing the system configuration continuously.

In some embodiments, the one or more engines include one or more distributed targeting AI learning engines pre-trained with misappropriation characteristics including predicated attack characteristics, randomized attack characteristics, and adversarial attack characteristics.

In some embodiments, the invention further comprising each engine checking explainability of the results of other engines and performs feature importance checks, statistical distribution checks, compliance checks, and accuracy of other engines with adversarial test samples.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, where:

FIG. 1 illustrates a dynamic conditioning for advanced misappropriation protection system environment, in accordance with embodiments of the present invention;

FIG. 2 illustrates a flowchart for dynamic optimization and adversarial configuration of artificial intelligence systems, in accordance with embodiments of the present invention;

FIG. 3 illustrates a flowchart for dynamic optimization and adversarial configuration of artificial intelligence systems, in accordance with embodiments of the present invention;

FIG. 4 illustrates a flowchart of the system architecture overview for dynamic conditioning for advanced misappropriation protection, in accordance with embodiments of the present invention;

FIG. 5 illustrates a flowchart of topology of engine reporting and performance evaluation, in accordance with embodiments of the present invention;

FIG. 6 illustrates a flowchart for pre-training and optimizing learning agents for misappropriation detection, in accordance with embodiments of the present invention;

FIG. 7 illustrates a flowchart for misappropriation profiling for authenticity identification, in accordance with embodiments of the present invention; and

FIG. 8 illustrates a flowchart for real-time new/emerging misappropriation identification for authenticity identification, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

In some embodiments, an “entity” may be a financial institution, business, insurance provider, health care provider, education institution, or the like that may include requiring identification of individuals for services/processes within the entity. Furthermore, an entity may include a merchant device, automated teller machine (ATM), entity device, or the like. For the purposes of this invention, a “communication” or a “user communication” may be any digital or electronic transmission of data, metadata, files, or the like. The communication may be originated by an individual, application, system within an entity. Furthermore, an “external party” may be one or more individuals, entities, systems, servers, or the like external to the entity. This may include third parties, partners, subsidiaries, or the like of the entity. A resource distribution, as used herein may be any transaction, property transfer, service transfer, payment, or another distributions from the user. A resource distribution may further include user authentications, locations, device usages, and the like. In some embodiments, event history may include historic resource distributions, user interactions, events the user, habits for the user, or the like.

The system provides misappropriation profiling for authenticity identification 800, in accordance with embodiments of the present invention. Misappropriation profiling identifies new/emerging misappropriations that are developed. The misappropriation profiling the new/emerging misappropriations into a separate channel and allows the individual to continue the misappropriation. The system gathers analytical data on the misappropriation and generates a synthetic misappropriation based on the misappropriation and injects the synthetic misappropriation into the authenticity identification streams and the neural network engines for future misappropriation identification.

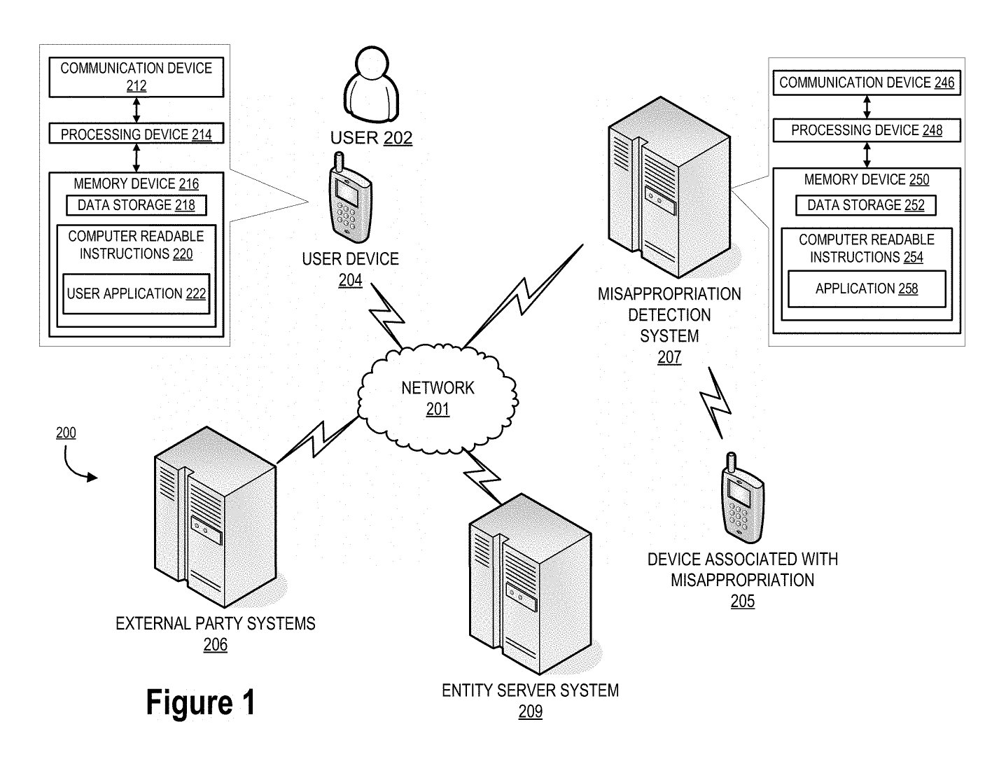

FIG. 1 illustrates a dynamic conditioning for advanced misappropriation protection system environment 200, in accordance with embodiments of the present invention. FIG. 1 provides the system environment 200 for which the distributive network system with specialized data feeds for extract information for information security vulnerability assessments for the user. FIG. 1 provides a unique system that includes specialized servers and system communicably linked across a distributive network of nodes required to perform the functions for advanced misappropriation protection.

As illustrated in FIG. 1, the misappropriation detection system 207 is operatively coupled, via a network 201 to the user device 204, the entity server system 209, a device associated with misappropriation 205, and to the external party systems 206. In this way, the misappropriation detection system 207 can send information to and receive information from the user device 204, entity server system 209, and the external party systems 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is one or more individuals or entities. In this way, the user 202 may be any individual or entity requesting access to one or more locations within an application, entity, or the like. FIG. 1 also illustrates a user device 204. The user device 204 may be, for example, a desktop personal computer, business computer, business system, business server, business network, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the external party systems 206, entity server system 209, and the misappropriation detection system 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222.

As further illustrated in FIG. 1, the misappropriation detection system 207 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the external party systems 206, entity server system 209, and the user device 204. As such, the communication device 246 generally comprises a modem, server, or other device for communicating with other devices on the network 201.

As further illustrated in FIG. 1, the misappropriation detection system 207 comprises computer-readable instructions 254 stored in the memory device 250, which in one embodiment includes the computer-readable instructions 254 of an application 258. In some embodiments, the memory device 250 includes data storage 252 for storing data related to the system environment 200, but not limited to data created and/or used by the application 258.

In one embodiment of the misappropriation detection system 207 the memory device 250 stores an application 258. Furthermore, the misappropriation detection system 207, using the processing device 248 codes certain communication functions described herein. In one embodiment, the computer-executable program code of an application associated with the application 258 may also instruct the processing device 248 to perform certain logic, data processing, and data storing functions of the application. The processing device 248 is configured to use the communication device 246 to communicate with and ascertain data from one or more of the entity server system 209 and/or user device 204.

In some embodiments, the user 202 may be utilizing the user device 204 to generate a communication. The communication may be a digital or electronic communication such as email, text message, or the like. The communication may further include information such as data, files, metadata, or the like associated with the user or the entity. The communication may be initiated by the user 202 with the desired receiver of the communication being an individual outside the entity and associated with an external party system 206. Upon generation of the communication, the user may attempt to send the communication with the information to the external party. The misappropriation detection system 207 recognizes the generation of the communication and performs a vulnerability assessment of the communication to approve the communication for a permit to send. The vulnerability assessment may be an evaluation process that is built into the entity server system 209 that evaluates the security of the data in the communication prior to being transmitted.

The misappropriation detection system 207 may operate to perform the authenticity identification processes. In some embodiments, the misappropriation detection system 207 may perform hierarchical learning of data and event history modeling to identify normal resource distribution of a user, interactions, events, habits, or the like. In this way, in some embodiments, the misappropriation detection system 207 may perform phase-based characterization of interactions and resource distribution for authenticity identification. In some embodiments, the misappropriation detection system 207 may perform collective profiling across channels for authenticity identification. In some embodiments, the misappropriation detection system 207 may perform learning engine cross training for authenticity identification. In some embodiments, the misappropriation detection system 207 may perform hierarchical learning profile optimization for authenticity identification. In some embodiments, the misappropriation detection system 207 may perform one or more of these functions to perform authenticity identification using dynamic hierarchical learning.

As illustrated in FIG. 1, the entity server system 209 is connected to the misappropriation detection system 207, user device 204, and external party systems 206. The entity server system 209 has the same or similar components as described above with respect to the user device 204 and misappropriation detection system 207. The entity server system 209 may be the main system server for the entity housing the entity email, data, documents, and the like. The entity server system 209 may also include the servers and network mainframe required for the entity.

As illustrated in FIG. 1, the device associated with misappropriation 205 may be monitored by the misappropriation detection system 207. The device associated with misappropriation 205 has the same or similar components as described above with respect to the user device 204 and misappropriation detection system 207. The device associated with misappropriation 205 may be the main system for misappropriation attempts on the authenticity of a user, external party, or entity.

It is understood that the servers, systems, and devices described herein illustrate one embodiment of the invention. It is further understood that one or more of the servers, systems, and devices can be combined in other embodiments and still function in the same or similar way as the embodiments described herein.

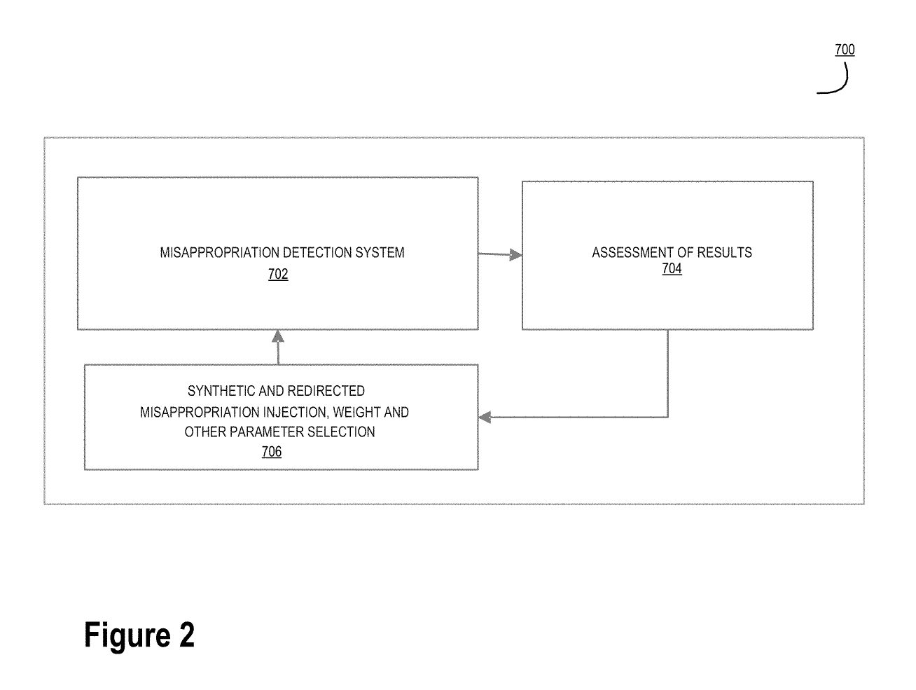

FIG. 2 illustrates a flowchart for dynamic optimization and adversarial configuration of artificial intelligence systems 700, in accordance with embodiments of the present invention. As illustrated, the dynamic optimization and adversarial configuration for artificial intelligence systems includes a misappropriation detection system. The misappropriation detection system 702 identifies adversarial threat vectors based on previously seen misappropriation cases, exhaustive and logical design space exploration of possible cases, and weakness assessment of the system. As illustrated in block 704, the results of the data from the data extraction of previously seen misappropriation cases, exhaustive and logical design space exploration of possible cases, and weakness assessment of the system are reviewed and an assessment of the results is generated.

As illustrated in block 706, the process 700 continues by generating synthetic and redirected misappropriation injections into the misappropriation detection system. The system weights and selects other parameters for injection. The misappropriation transactions are generated to train the misappropriation detection system 702 in an adversarial fashion, tackle an upcoming trend, or the like. A separate twin artificial intelligence (AI) engine continually injects misappropriation transactions into the system and checks the system health. As such, this serves as a proxy to conscious decisions making process assessing the health of each transaction and feeding back controlling the specifics of the system, such as hyper-parameter, weight selection, feedback or the like, and adversarial data generation to train the twin system. If the misappropriation detection system 702 cannot detect the injected misappropriation then the parameters and/or the design of the injection is recalibrated and adjusted.

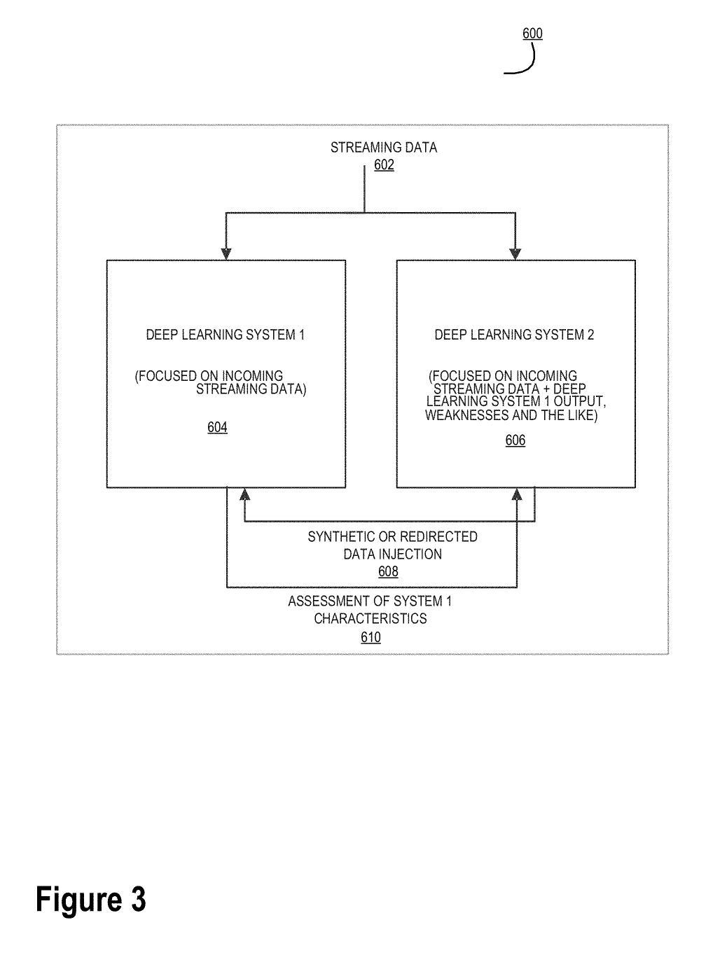

FIG. 3 illustrates a flowchart for dynamic optimization and adversarial configuration of artificial intelligence systems 600, in accordance with embodiments of the present invention. The streaming data 602 may be streamed and processed through learning systems. These may include deep learning system 1 604 and deep learning system 2 606. In some embodiments, deep learning system 1 604 is a learning system within the misappropriation detection system that focuses primarily on the incoming streaming data. In some embodiments, deep learning system 2 606 is a learning system within the misappropriation detection system that focuses on incoming streaming data and the output from deep learning system 1 to identify weaknesses in the outputs. As illustrated the assessment of deep learning system 1 characteristics are presented to deep learning system 2 for evaluation, as illustrated in block 610. Deep learning system 2 then continues by producing or redirected synthetic data injection into deep learning system 1, as illustrated in block 608 for refinement of the deep learning system 1 604 system and screening of the incoming streaming data.

In this way, when a transaction is successfully detected it is taken out of the transaction profile. Both synthetic and real misappropriation data from the one or more sources are fed into the models on a continuous basis. Similar to a vaccination pattern, the misappropriation patterns emerge in a similar segment, such as geolocation, channel, type, or the like are then fed into neural networks or learning engines that are expected to detect misappropriation in unaffected segments or individuals. Thus reducing misappropriation by learning of patterning in one location or segment and applying that learned data to the learning system for unrelated data streams for an indication of and prevention of misappropriation within those streams.

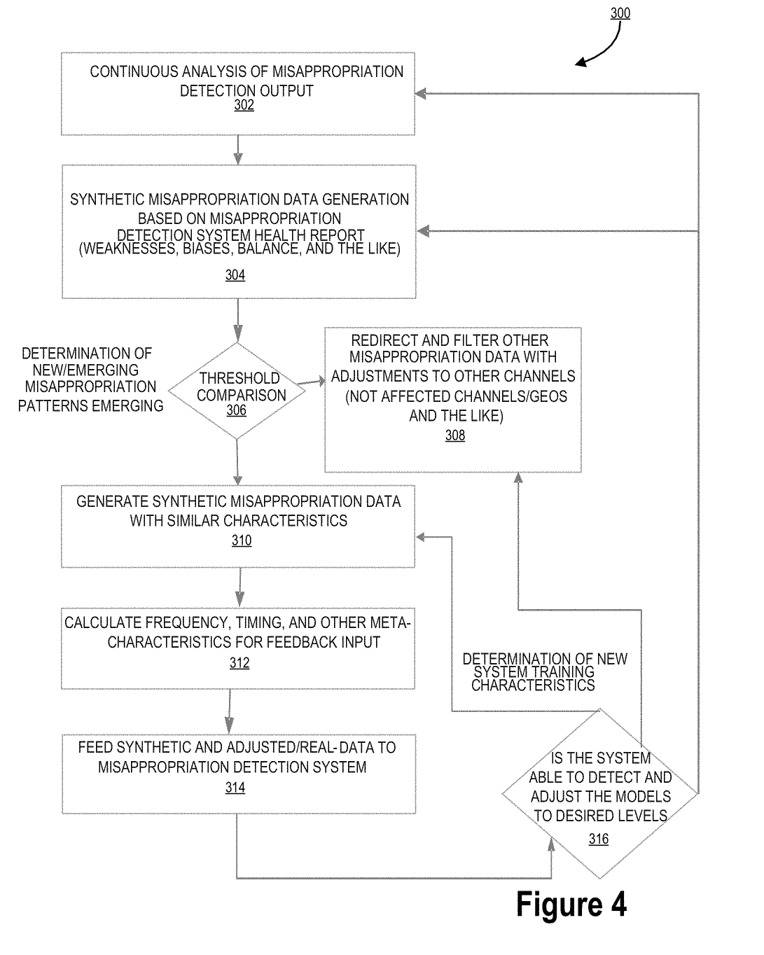

FIG. 4 illustrates a flowchart of the system architecture overview for dynamic conditioning for advanced misappropriation protection 300, in accordance with embodiments of the present invention. As illustrated in block 302, the process 300 is initiated by a continuous analysis of misappropriation detection output. Next, as illustrated in block 304 the system may generate synthetic misappropriation data based on misappropriation detection system health reports, such as weaknesses, biases, balances, and the like. Next, the system performs a threshold comparison, as illustrated in block 306. In this way, the system determines new/emerging misappropriation patterns that are emerging in transactions. If the threshold is not met, the system may redirect and filter other misappropriation data with adjustments to other channels, not affected channels or geographic location, as illustrated in block 308. As illustrated in block 310, the process may continue upon threshold comparison to generate a synthetic misappropriation data with similar characteristics. The system continues in block 312 by calculating frequency, timing, and other meta-characteristics for feedback input. The calculated frequency, timing, and meta-characteristics are then feed as synthetic data and adjusted along with real-data to the misappropriation detection system, as illustrated in block 314.

Next, as illustrated in block 316, the process 300 continues by determining if the system is able to detect and adjust the models to the desired level. If not, the system determines new system training characteristics and generates synthetic misappropriation data with similar characteristics, as illustrated in block 310. Furthermore, the process 300 may input back into blocks 302 and 304. Finally, based on the detection, the system may redirect and filter other misappropriation data with the adjustments to other channels, as illustrated in block 308.

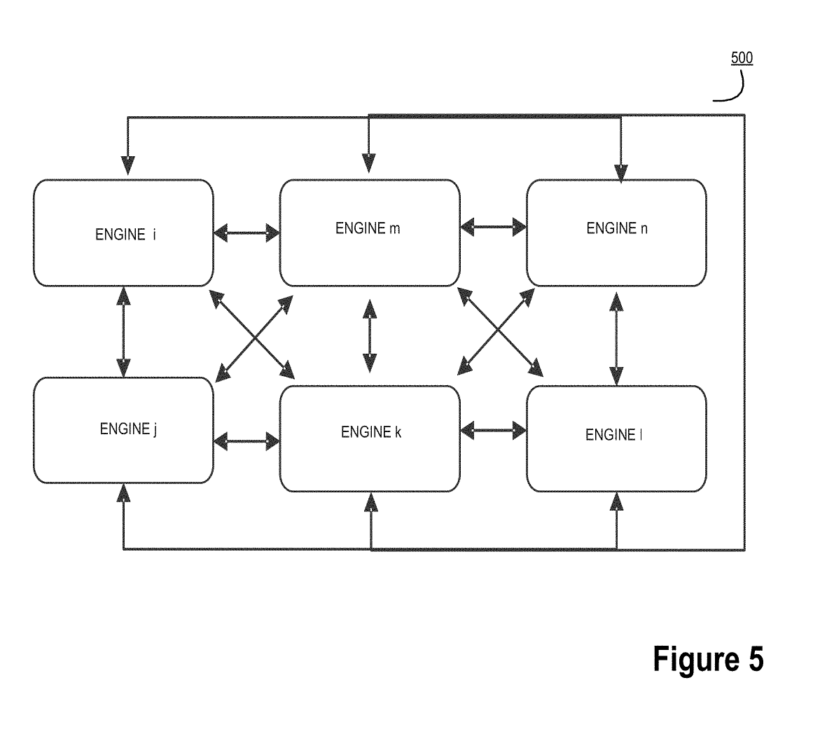

FIG. 5 illustrates a flowchart of topology of engine reporting and performance evaluation 500, in accordance with embodiments of the present invention. As illustrated, an embodiment of the invention where engines are illustrated in a topology where each of the various engines reports and evaluates each other performance. The invention comprises a dynamic optimization and adversarial configuration of artificial intelligence system, such as learning systems or agents. As illustrated in the Example of FIG. 5 there are Engine I, Engine m, Engine n, Engine j, Engine k, and Engine l. The engines are neural network engines that are categorized to identify one or more normal or misappropriation events.

Each learning engine may comprise a neural engine within the system is trained for misappropriation, non-misappropriation, and the like. The results from each engine are cross compared to generate a complete misappropriation profile that covers a range of factors for the input. These learning network engines may be based on neural networks, ensemble of neural networks, hybrids, machine learning, or the like. The learning network engines are trained for misappropriation identification and/or normal action identification and cross comparison of results to output a misappropriation vector for recommendation actions. The neural network engines may include misappropriation identification and normal action identification within various sectors such as location, phases, neighborhoods, families, various misappropriation types such as client segments, account takeover characteristics, emerging misappropriation, and the like.

In some embodiments, one or more of the engines are continually updated with identified new/emerging misappropriations that are developed. With gathered analytical data on the new/emerging misappropriation, the one or more engines may be presented with a synthetic misappropriation based on the misappropriation and injects the synthetic misappropriation into the authenticity identification streams and the neural network engines for future misappropriation identification.

Each engine, checks the explainability of the results of the other engines. Furthermore, each engine performs feature importance checks, statistical distribution checks, such as analyzing how the input and outputs are distributed, compliance checks based on regulations and internal policies, and each engine checks the accuracy of the other engines with adversarial test samples.

In some embodiments, there are two major components to the invention for dynamic optimization and adversarial configuration of the artificial intelligence systems. First, the system comprises a centralized component architecture to ensure fairness and compliance of the output of all of the engines. Using the centralized components of the system generates an implicit internal feedback loop as illustrated in FIG. 5, with each engine evaluating its own results over time. These results may be used for reporting. Furthermore, also illustrated in FIG. 5 includes an explicit external feedback loop. The explicit external feedback loop may comprise a twin feedback loop or other configuration, where the engines are responsible for evaluation and correcting each other.

As illustrated in FIG. 5, the invention comprises a distributed system architecture where a collection of distributed AI engines are coded to work together to ensure fairness and compliance of the system. In this way, each engine is coded for reporting and evaluation responsibilities, policing abilities for evaluation of responsibilities than reporting, and for dynamically changing responsibilities based on an identified success rate of filing issues in other engines.

The distributed system architecture is essential in ensuring fairness/compliance and other critical in cases where a large number of embedded/autonomous engines might be involved. The system dynamically optimizes the responsibilities of the individual engines such that the criteria for fairness and compliance are met with sufficient inspection and reporting on involved parties. Furthermore, in some embodiments a system level collaborative/distrusted protocol is generated and used to assess the overall quality of the solution, such as assessing the reporting and evaluation responsibilities of the engines and dynamically optimizing the system configuration continuously.

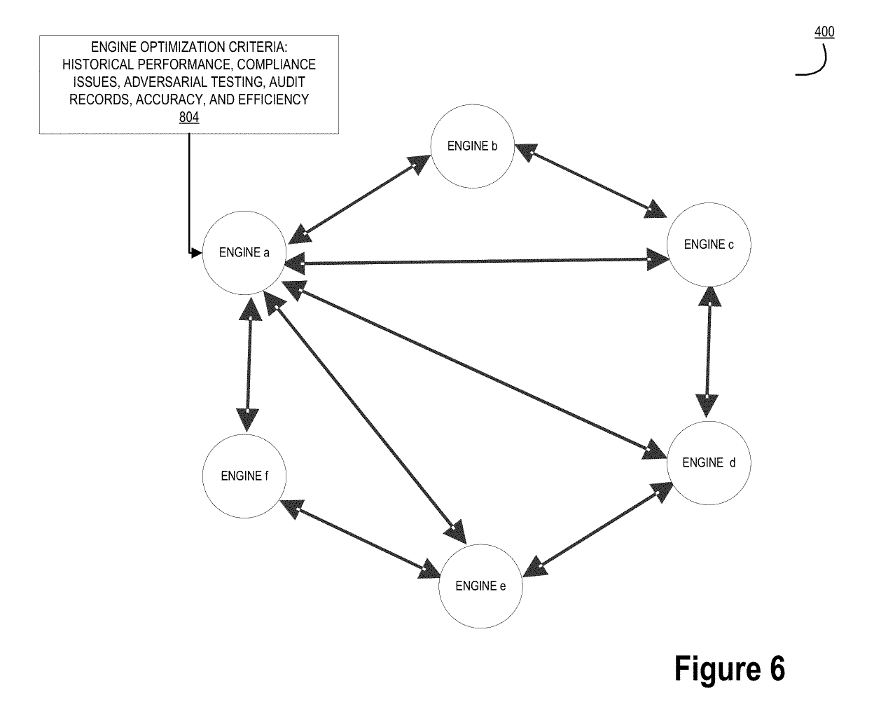

FIG. 6 illustrates a flowchart for pre-training and optimizing learning agents for misappropriation detection 400, in accordance with embodiments of the present invention. As illustrated in block 402, the engines may be optimized based on historical performance, compliance issues, adversarial testing, audit records, accuracy, and efficiency. In some embodiments, the engines may be ranked on the number and severity of the issues that they identify in streaming data and in the other engines. In other embodiments, the engines may be organized in an ensemble fashion. With respect to ranking on the number and severity, this achieves an engine that generates adversarial data streams to test others, checks/audits the reports from other engines, and compares other engine output to its own results or results from similar engines for long term evaluations.

In other embodiments, the engines may be organized in an ensemble fashion. In this way each engine and its historical performance in fairness, compliance identification, and identifying other engine faults are viewed together for consideration. This ensemble system then outputs a result that is facilitating an optimization for the overall object functions. In this way, the systems stores historical performance of the individual engines in compliance violations, fairness criteria, accuracy, evaluation of other results, audits, and the like. Over conditions of uncertain historical success rates, accuracy, audit performance, and the like are used to assign votes to the individual engines in the ensemble fashion layout.

A predetermined collection of configurations can be used as part of the system design where audit and audited roles are assigned dynamically. This assignment is dynamically done via randomness injection within the system over an allocated time period. These configurations may include auditors, audits, adversarial nodes, and high-level criteria requirements. The collection of engines may dynamically configure themselves according to the criteria set for requirements, such as accuracy, audit performance, and the like. The collection of learning engines may include a fabric of engines or the like.

The collection of learning engines may perform cross training that transmits requests for identification, authentication, or access to secure locations along with historical data through multiple engines that are specialized in specific misappropriation identification to output a complete authentication action for the transaction of the user. Each learning engine may comprise a neural engine within the system is trained for misappropriation, non-misappropriation, and the like. The results from each engine are cross compared to generate a complete misappropriation profile that covers a range of factors for the input.

After the allocation, the system may be evaluated and reconfigured into a new configuration during the next time period. The system may also incorporate results from the last runs, changes in data, and environmental conditions into the next dynamic configuration. A predetermined set of rules can make for adjustments in the time period length for changes in the roles, responsibilities of individual engines and the like based on performance, points, audit history, and the like.

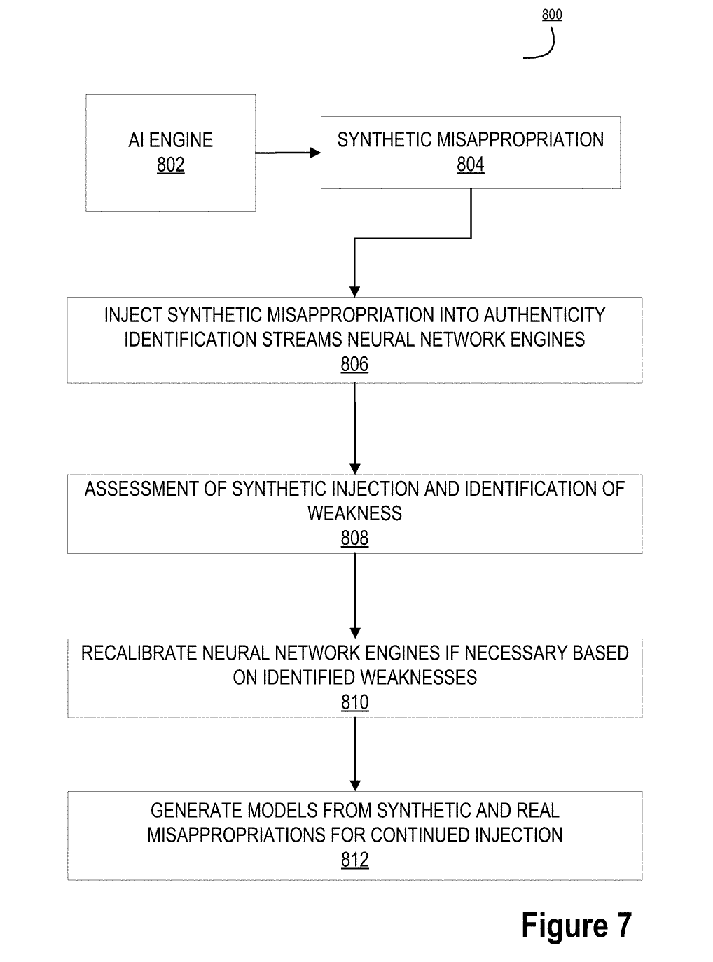

FIG. 7 illustrates a flowchart for misappropriation profiling for authenticity identification 800, in accordance with embodiments of the present invention. Misappropriation profiling identifies new/emerging misappropriations that are developed. The misappropriation profiling the new/emerging misappropriations into a separate channel and allows the individual to continue the misappropriation. The system gathers analytical data on the misappropriation and generates a synthetic misappropriation based on the misappropriation and injects the synthetic misappropriation into the authenticity identification streams and the neural network engines for future misappropriation identification.

As illustrated in block 802, the process 800 may involve one or more AI engines grouped together to perform tasks such as audit, control, and/or the like.

In some embodiments, one concept of the one or more AI engines includes a self-evaluation of each engine. So whenever an engine provides an output, the engine evaluates that output based on criteria, policies, regulations, the engine bias, and/or ethical manner of output.

In some embodiments, another concept of the one or more AI engines includes the engines capability to evaluate the other one or more engines within the collection. The evaluation is performed in a specific way including generation of synthetic data, observations, run audit/compliance checks of the other engines.

In some embodiments, another concept of the one or more AI engines includes a large number of fabric or population of interconnected engines. One or more of the interconnected engines may dynamically be assigned responsibilities to test, audit, generate synthetic data, or the like to test other engines. In some embodiments, there may be a point system after evaluation of data for assessment of the output and forcing the engines to comply with policies or regulations.

In some embodiments, another concept of the one or more AI engines includes dynamically optimization of the roles and configurations of the engines to ensure meeting of criteria for the engines

In one embodiment, where there is a pairing of two engines, they may act like twin AI engines within the authenticity identification system. The AI engines generate a synthetic misappropriation, as illustrated in block 804. The AI engines are separate from the authenticity system and network and is used to continually inject misappropriations into the stream and check for system health. The synthetic misappropriation may be based on previously seen misappropriation, exhaustive and logical design space exploration of possible historic misappropriations, previously identified weaknesses of the authenticity identification system. In this way, the AI engines may generate an adversarial threat vector for implementation as a synthetic misappropriation. These synthetic misappropriations are generated to train the system in an adversarial environment.

As illustrated in block 806, once the synthetic misappropriation has been generated, the system may inject the synthetic misappropriation into the authenticity identification process streams and/or the neural network engines associated therewith. As illustrated in block 808, the process 800 continues by assessing the processing of the synthetic injection and identify any weaknesses in the authentication identification network. In this way, there may be one or more weaknesses that may not trigger identification of a misappropriation in the way the neural network engine should be triggering the misappropriation. In this way, the system identifies a weakness that requires learning by the neural network engine.

Next, as illustrated in block 810, the process 800 continues by recalibrating the neural network engines, if necessary, based on the identified weaknesses. In this way, the system continues to perform learning in real-time to continually identify new/emerging misappropriations that are developed. Finally, as illustrated in block 812, the process 800 continues by generating models from the synthetic and real misappropriations for continued injection and learning for the engines.

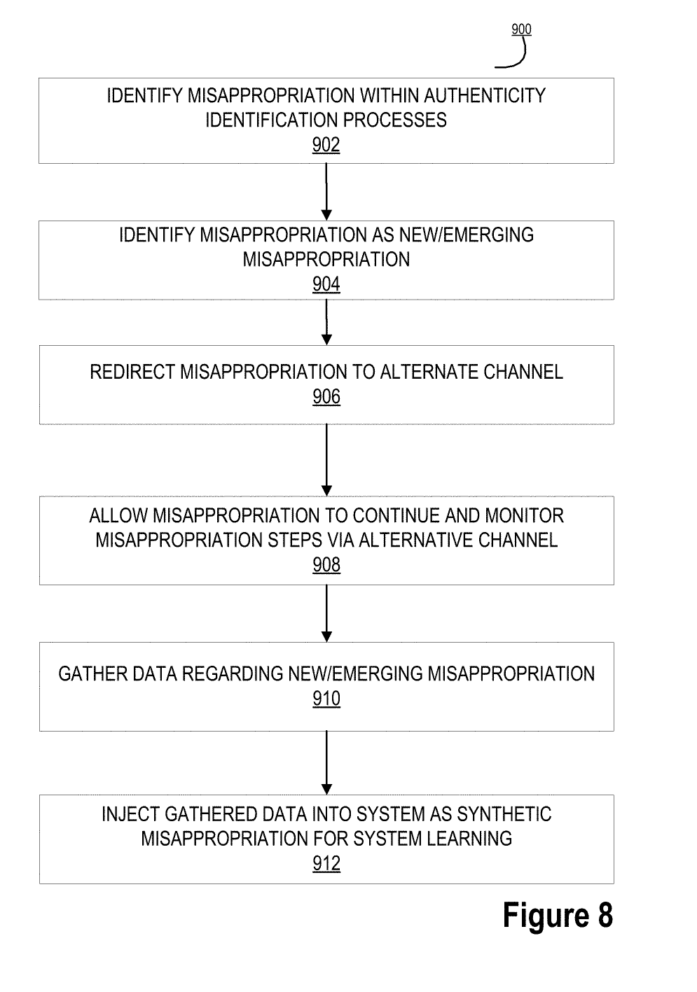

FIG. 8 illustrates a flowchart for real-time new/emerging misappropriation identification for authenticity identification 900, in accordance with embodiments of the present invention. As illustrated in block 902, the process 900 is initiated by identifying a misappropriation within the authenticity identification processes. The misappropriation is further reviewed by the system prior to directly denying the misappropriation or channel associated therewith. Upon review of the misappropriation, the system may identify the misappropriation as a new/emerging misappropriation, as illustrated in block 904. In this way, the system wants to learn more about the new/emerging misappropriation for future detection and processing. As such, the system allows the misappropriation to continue to be performed by the individual performing the misappropriation. However, the system redirects the misappropriation to an alternative channel, as illustrated in block 906. In this way, to the individual performing the misappropriation, the process looks correct, however, the system is performing a fake process for the individual to continue. The system generates more information about the individual and the misappropriation so that the system may learn more data about the new/emerging misappropriation.

As illustrated in block 908, the process 900 continues by allowing for that misappropriation to continue and to monitor the misappropriation steps the individual is performing via the alternative channel. As such, the system continues to learn the new/emerging misappropriation for subsequent identification. In this way, as illustrated in block 910, the process 900 continues by gathering data regarding the new/emerging misappropriation based on continuing connection with the individual attempting the misappropriation. In this way, the system may ask additional authenticity questions, track geolocation, identify channels, or the like associated with the attempted misappropriation for further identification of potential future similar misappropriations. Finally, as illustrated in block 912, once the data about the misappropriation has been digested, the system may inject the gathered data into as synthetic misappropriations for system and engine learning.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authentication and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for real-time dynamic conditioning, the system comprising:
one or more artificial intelligence (AI) engines within a collection of one or more engines dynamically performing dynamic conditioning, the one or more engines comprising one or more memory devices with computer-readable program code stored thereon, one or more communication devices connected to a network, and one or more processing devices, wherein the one or more processing devices are configured to execute the computer-readable program code to:
self-evaluate an output each of the one or more engines via performing policy checks and assessments on each of the one or more engines own results;
evaluate an output from other one or more engines within the collection, wherein evaluating the output from the other one or more engines includes generating synthetic data, performing observations, and/or running compliance checks of the other one or more engines; and
dynamically assign and change responsibilities of the one or more engines within the population.

2. The system of claim 1, wherein self-evaluating each of the one or more engines further comprises implementing policies on fairness, explainability, and optimization criteria via the self-evaluation and assessment and control of the engine.

3. The system of claim 1, further comprising dynamic optimization and adversarial configuration of real-time streaming data, wherein each of the one or more engines comprise a collection of one or more distributed targeting artificial intelligence engines.

4. The system of claim 1, further comprises fairness and compliance output monitoring comprising generating an implicit internal feedback loop, were each of the one or more engines evaluates each of the one or more engines results overtime and an explicit external feedback loop where the engines are responsible for evaluation and correcting other engine results.

5. The system of claim 1, wherein dynamically assigning and changing the responsibilities of the one or more engines within the collection further comprises a point system for assessment of the output and forcing the one or more engines to comply with policies or regulations.

6. The system of claim 1, further comprising:
generating an authenticity identification procedure, wherein the authenticity identification procedure comprise the one or more engines for dynamic optimization and adversarial configuration of real-time streaming data;
building a synthetic misappropriation packet for injection, wherein the synthetic misappropriation packet contains a synthetic version of misappropriated resource distribution identified and built using gathered data regarding the misappropriated resource distribution;
injecting the synthetic misappropriation packet into the collection of the one or more engines associated with the authenticity identification procedures for learning of the emerging misappropriation; and
placing responsibility on the learning engines for reporting and evaluation for self-evaluation and correction of results from ingestion of injected synthetic misappropriation packet.

7. The system of claim 6, further comprising:
identifying a resource distribution being initiated as a non-authentic resource distribution based on the one or more authenticity identification procedures, wherein the non-authentic resource distribution is a misappropriated resource distribution;
reviewing the misappropriated resource distribution and identify the misappropriated resource distribution as an emerging misappropriation;
redirecting the misappropriated resource distribution to an alternative channel and allow for the misappropriated resource distribution to continue; and
gathering data regarding communication with an individual of the misappropriated resource distribution.

8. The system of claim 1, wherein evaluating an output from other one or more engines within the collection further comprising a collaborative/distrusted protocol for assessing the overall quality of a solution, such as assessing the reporting and evaluation responsibilities of the learning engines and dynamically optimizing the system configuration continuously.

9. The system of claim 1, wherein the one or more engines include one or more distributed targeting AI learning engines pre-trained with misappropriation characteristics including predicated attack characteristics, randomized attack characteristics, and adversarial attack characteristics.

10. The system of claim 1, further comprising each engine checking explainability of the results of one or more engines and performs feature importance checks, statistical distribution checks, compliance checks, and accuracy of the one or more engines with adversarial test samples.

11. A computer-implemented method for real-time dynamic conditioning, the method comprising:
providing one or more engines within a collection of one or more engines dynamically performing dynamic conditioning, the one or more engines comprising one or more computer processing device and a non-transitory computer readable medium, where the computer readable medium comprises configured computer program instruction code, such that when said instruction code is operated by said computer processing device, said computer processing device performs the following operations:
self-evaluate an output each of the one or more engines via performing policy checks and assessments on each of the one or more engines own results;
evaluate an output from other one or more engines within the collection, wherein evaluating the output from the other one or more engines includes generating synthetic data, performing observations, and/or running compliance checks of the other one or more engines; and
dynamically assign and change responsibilities of the one or more engines within the collection.

12. The computer-implemented method of claim 11, wherein self-evaluating each of the one or more engines further comprises implementing policies on fairness, explainability, and optimization criteria via the self-evaluation and assessment and control of the engine.

13. The computer-implemented method of claim 11, further comprises fairness and compliance output monitoring comprising generating an implicit internal feedback loop, were each of the one or more engines evaluates each of the one or more engines results overtime and an explicit external feedback loop where the engines are responsible for evaluation and correcting other engine results.

14. The computer-implemented method of claim 11, wherein dynamically assigning and changing the responsibilities of the one or more engines within the collection further comprises a point system for assessment of the output and forcing the one or more engines to comply with policies or regulations.

15. The computer-implemented method of claim 11, further comprising:
generating an authenticity identification procedure, wherein the authenticity identification procedure comprise the one or more engines for dynamic optimization and adversarial configuration of real-time streaming data;
building a synthetic misappropriation packet for injection, wherein the synthetic misappropriation packet contains a synthetic version of misappropriated resource distribution identified and built using gathered data regarding the misappropriated resource distribution;
injecting the synthetic misappropriation packet into the collection of the one or more engines associated with the authenticity identification procedures for learning of the emerging misappropriation; and
placing responsibility on the learning engines for reporting and evaluation for self-evaluation and correction of results from ingestion of injected synthetic misappropriation packet.

16. The computer-implemented method of claim 15, further comprising:
identifying a resource distribution being initiated as a non-authentic resource distribution based on the one or more authenticity identification procedures, wherein the non-authentic resource distribution is a misappropriated resource distribution;
reviewing the misappropriated resource distribution and identify the misappropriated resource distribution as an emerging misappropriation;
redirecting the misappropriated resource distribution to an alternative channel and allow for the misappropriated resource distribution to continue; and
gathering data regarding communication with an individual of the misappropriated resource distribution.

17. The computer-implemented method of claim 11, further comprising each engine checking explainability of the results of one or more engines and performs feature importance checks, statistical distribution checks, compliance checks, and accuracy of the one or more engines with adversarial test samples.

18. A system for real-time dynamic conditioning, the system comprising:
one or more artificial intelligence (AI) engines within a collection of one or more engines dynamically performing dynamic conditioning, the one or more engines comprising one or more memory devices with computer-readable program code stored thereon, one or more communication devices connected to a network, and one or more processing devices, wherein the one or more processing devices are configured to execute the computer-readable program code to:
self-evaluate an output each of the one or more engines via performing policy checks and assessments on each of the one or more engines own results;
evaluate an output from other one or more engines within the collection, wherein evaluating the output from the other one or more engines includes generating synthetic data, performing observations, and/or running compliance checks of the other one or more engines;
build a misappropriation packet for injection, wherein the misappropriation packet contains a version of misappropriated resource distribution identified and built using gathered data regarding the misappropriated resource distribution; and
inject the synthetic misappropriation packet into the collection of engines associated with an authenticity identification procedures for learning of the emerging misappropriation.

19. The system of claim 18, wherein self-evaluating each of the one or more engines further comprises implementing policies on fairness, explainability, and optimization criteria via the self-evaluation and assessment and control of the engine.

20. The system of claim 18, further comprising dynamic optimization and adversarial configuration of real-time streaming data, wherein each of the one or more engines comprise a collection of one or more distributed targeting artificial intelligence engines.

21. The system of claim 18, further comprises fairness and compliance output monitoring comprising generating an implicit internal feedback loop, were each of the one or more engines evaluates each of the one or more engines results overtime and an explicit external feedback loop where the engines are responsible for evaluation and correcting other engine results.

22. The system of claim 18, wherein evaluating an output from other one or more engines within the collection further comprising a collaborative/distrusted protocol for assessing the overall quality of a solution, such as assessing the reporting and evaluation responsibilities of the learning engines and dynamically optimizing the system configuration continuously.

23. The system of claim 18, wherein the one or more engines include one or more distributed targeting AI learning engines pre-trained with misappropriation characteristics including predicated attack characteristics, randomized attack characteristics, and adversarial attack characteristics.

24. The system of claim 18, further comprising each engine checking explainability of the results of one or more engines and performs feature importance checks, statistical distribution checks, compliance checks, and accuracy of the one or more engines with adversarial test samples.
